(19) United States
(12) Patent Application Publication
(10) Pub. No.: US 2026/0267838 A1
(43) Pub. Date: Sep. 10, 2026

(54) SYSTEMS AND METHODS FOR PROCESSING FILES

(71) Applicant: FMR LLC, Boston, MA (US)

(72) Inventor: David William Toupin, Brookline, NH (US)

(21) Appl. No.: 19/073,362

(22) Filed: Mar. 7, 2025

(51) Int. Cl. G06F 16/22

(52) U.S. Cl. CPC G06F 16/221

(57) ABSTRACT

A method is provided for automatically comparing two text files comprising a first file and a second file, where the file type of the first file is a fixed-width file type. The method includes converting each of the two text files into respective ones of two tables, each table storing data extracted from the corresponding text file. Each table comprises (i) a plurality of records with each record forming a row and (ii) a plurality of fields with each field forming a column. The method further includes comparing the respective tables corresponding to the first and second files to determine one or more differences between the first and second files.

### BACKGROUND

### Technical Field

This application generally relates to systems, methods and apparatuses, including computer program products, for automatically parsing and comparing data in text files.

### Background Information

In today's market, a company, such as an insurance company, may need to process thousands of text files back and forth with vendors. File layouts vary extensively across vendors with each file customized for specific conditions. Extracting data from each file usually requires customized maps that need to be created and then maintained every time the layout is updated. Along with extracting data for file analysis, comparing two similar files is a critical business function. Standard comparison products need the custom maps along with comparison-specific mapping to identify key data elements. Thus, existing data file extraction and comparison products require high degrees of manual intervention to create these maps and key values.

Therefore, there is need for a tool that can provide automatic data extraction from files of different types and automatic analysis and compare capabilities with minimal user setup or mapping.

### SUMMARY

The present invention features systems and methods for automatically converting a text file to a table format with individual records and elements and comparing multiple converted files at a record/element level. In some embodiments, a pattern-matching approach is used to extract the individual records and elements from a text file, which is different from other file processing tools that use extensive custom maps or user inputs. More specifically, in some embodiments, the present invention features a tool that applies a pattern recognition algorithm on a file to determine the file type (e.g., delimited, fixed width, ANSI, or single client feed file type). The tool then uses pattern recognition on the data of the file to determine individual elements.

In one aspect, the present invention features a method for automatically comparing two text files comprising a first file and a second file. The method includes receiving, by a computing device, the first and second files with respective file types, where the file type of the first file is a fixed-width file type. The method also includes converting, by the computing device, each of the two text files into respective ones of two tables, each table storing data extracted from the corresponding text file. Each table comprises (i) a plurality of records with each record forming a row, (ii) a plurality of fields with each field forming a column and (iii) a key field per record storing a unique identifier of each record. Converting the first file that has the fixed-width file type comprises receiving, by the computing device, a set of parameter settings that define a set of patterns, executing, by the computing device, a pattern-matching algorithm using the set of patterns on a first subset of the plurality of records to identify a set of potential patterns in the records, executing, by the computing device, the pattern-matching algorithm using each of the set of potential patterns on a second subset of the plurality of records to determine a number of times each potential pattern is repeated in the second subset of records, if the number of times a potential pattern is repeated exceeds a threshold, setting, by the computing device, the repeated potential pattern as a column of the first file; and generating, by the computing device, the table comprising the records as the rows and the repeated potential patterns exceeding the threshold as the columns. The method further includes comparing the respective tables corresponding to the first and second files to determine one or more differences between the first and second files.

In another aspect, the present invention features a computer-implemented system for automatically comparing two text files comprising a first file and a second file. The computer-implemented system comprises a computing device having a memory for storing instructions. The instructions, when executed, configured the computer-implemented system to provide an input module configured to receive the first and second files with respective file types. The file type of the first file is a fixed-width file type. The input module is. configured to automatically determine the file type of the second file. The computer-implemented system also provides a table creation module configured to convert each of the two text files into respective ones of two tables, each table storing data extracted from the corresponding text file. Each table comprises (i) a plurality of records with each record forming a row, (ii) a plurality of fields with each field forming a column and (iii) a key field per record storing a unique identifier of each record. The table creation module is configured to convert the first file that has the fixed-width file type by receiving a set of parameter settings that define a set of patterns to be matched, identifying a plurality of columns in the first file by scanning through each of the plurality of records in the first file to match the patterns, each identified pattern comprises a column, and generating the table comprising the records as the rows and the identified patterns as the columns. The computer-implemented system further provides a comparison module configured to compare the respective tables corresponding to the first and second files to determine one or more differences between the first and second files.

Any of the above aspects can include one or more of the following features. In some embodiments, the file type of the second file is one of American National Standards Institute (ANSI), delimited, fixed-width, SCF, or Excel file type. In some embodiments, the patterns comprise at least one of multiple spaces, single space, date in one or more formats, currency in one or more formats and social security number in one or more formats.

In some embodiments, if the file type of the second file is ANSI, converting the second file into a table comprises scanning the second file in its entirety to identify segments present and a maximum number of elements per segment and creating one field per segment and element combination. In some embodiments, data from the second file is loaded into the table by loading ANSI header records into a first record of the table and loading data between segments into a single record per person by using segment identifiers and order to load data to the table in the correct fields.

In some embodiments, if the file type of the second file is delimited, converting the second file into a table comprises if the second file has column headers, using the column headers to create one field per header, and if the second file has no column headers, determining a maximum number of delimiters per record in the file and creating fields with generic column names based on the maximum number of delimiters. In some embodiments, data from the second file is loaded into the table by loading each file record into a record in the table using the delimiters to move between elements.

In some embodiments, if the file type of the second file is Excel, converting the second file into a table comprises creating and populating fields in the table with fields from the second file.

In some embodiments, the file type of each of the two text files is automatically identified and each file is automatically converted into its respective table based on its file type.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary diagram of a file processing system used in a computing environment for processing and analyzing files, according to some embodiments of the present invention.

FIG. 2 shows an exemplary process utilizing the file processing system of FIG. 1 to process and analyze files, according to some embodiments of the present invention.

FIG. 3 shows conversion of an exemplary ANSI 834 file into a data table using the conversion process of FIG. 2, according to some embodiments of the present invention.

FIG. 4 shows conversion of an exemplary delimited file into a data table using the conversion process of FIG. 2, according to some embodiments of the present invention.

FIG. 5 shows conversion of an exemplary SCF file into a data table using the conversion process of FIG. 2, according to some embodiments of the present invention.

FIG. 6 shows an exemplary graphical user interface provided by the input module of the file processing system of FIG. 1 for allowing a user to specify parameter settings for determining patterns in a fixed width file, according to some embodiments of the present invention.

FIG. 7 shows conversion of an exemplary fixed-width file into a data table using the conversion process of FIG. 2, according to some embodiments of the present invention.

FIG. 8 shows another graphical user interface provided by the input module of the file processing system for receiving input files from a user for table conversion and comparison purposes, according to some embodiments of the present invention.

### DETAILED DESCRIPTION

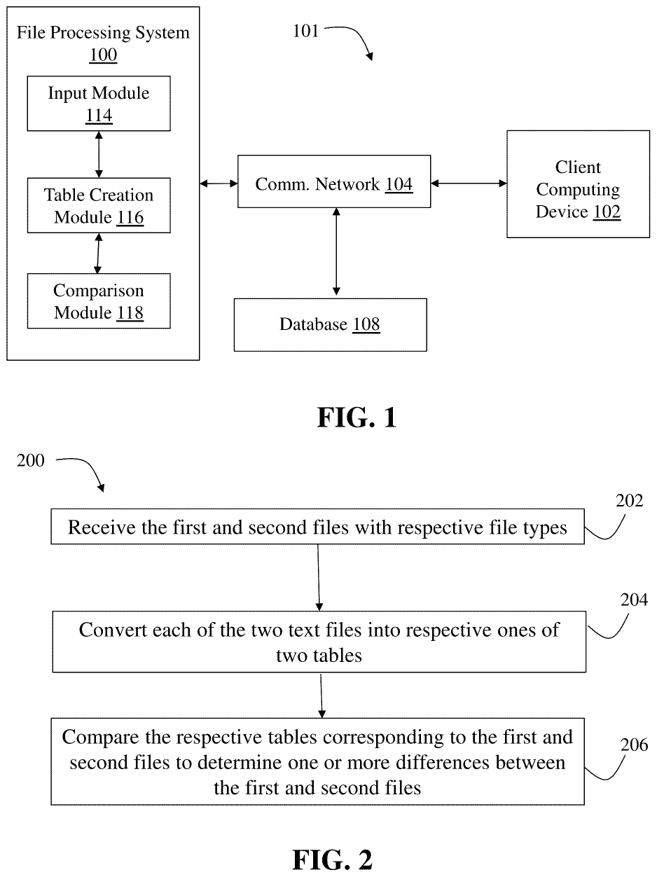

FIG. 1 shows an exemplary diagram of a file processing system 100 used in a computing environment 101 for processing and analyzing files, according to some embodiments of the present invention. As shown, computing environment 101 generally includes at least one client computing device 102, a communication network 104, the file processing system 100, and at least one database 108.

The client computing device 102 can be associated with a user, such as an analyst. The client computing device 102 can connect to the communication network 104 to interact with the file processing system 100 and/or the database 108 to provide inputs and receive outputs for display to the user. Exemplary computing devices 102 include, but are not limited to, telephones, desktop computers, laptop computers, tablets, mobile devices, smartphones, and internet appliances. It should be appreciated that other types of computing devices that are capable of connecting to the components of the computing environment 101 can be used without departing from the scope of invention. Although FIG. 1 depicts a single computing device 102, it should be appreciated that the computing environment 101 can include any number of client devices for communication by any number of users.

The communication network 104 enables components of the computing environment 101 to communicate with each other to perform the process of call agent evaluation. The network 104 may be a local network, such as a LAN, or a wide area network, such as the Internet and/or a cellular network. In some embodiments, the network 104 is comprised of several discrete networks and/or sub-networks (e.g., cellular to Internet) that enable the components of the system 100 to communicate with each other.

The file processing system 100 is a combination of hardware, including one or more processors and one or more physical memory modules and specialized software engines that execute on the processor of the image generation system 100, to receive data from other components of the computing environment 101, transmit data to other components of the computing environment 101, and perform functions as described herein. As shown, the file processing system 100 executes an input module 114, a table conversion module 116, and a comparison module 118. These sub-components and their functionalities are described below in detail. In some embodiments, the various components of the file processing system 100 are specialized sets of computer software instructions programmed onto a dedicated processor in the system 100 and can include specifically designated memory locations and/or registers for executing the specialized computer software instructions.

The database 108 is a computing device (or in some embodiments, a set of computing devices) that is coupled to and in communication with the file processing system 100 and is configured to provide, receive and store various types of data received and/or created for processing and analyzing files. In some embodiments, all or a portion of the database 108 is integrated with the file processing system 100 or located on a separate computing device or devices. For example, the database 108 can comprise one or more databases, such as MySQL™ available from Oracle Corp. of Redwood City, California.

FIG. 2 shows an exemplary process 200 utilizing the file processing platform 100 of FIG. 1 to process and analyze files, according to some embodiments of the present invention. The process starts at step 202 with the input module 114 of the file processing system 100 receiving at least two files for processing and analysis. The files are uploaded by a user via a corresponding client computing device 102. Each of the files is a text file and has its own file type, such as an American National Standards Institute (ANSI) file type, a single client feed (SCF) file type, a delimited file type, a fixed-width file type or an Excel file type. For example, a file can be a health file that includes a patient's health information.

In some embodiments, the input module 114 applies an algorithm that is configured to analyzes the file structure of each input file for patterns that match a known file type, thereby automatically identifying the file type of the input file. For example, the algorithm can identify an Excel file by checking for “.xls” in the file name extension. In addition, if an Excel file has multiple tabs, the input module 114 can give the user the choice of uploading a particular tab only. The algorithm can identify an ANSI file by reading the first three characters of the file and verifying that these characters comprise the term “ISA.” The algorithm can identify a delimited file by searching for the occurrences of known delimiters in the file. In some embodiments, the file is identified as a delimited file if the number and/or rate of occurrences of known delimiters exceeds a threshold, e.g., the occurrences are greater than 3 per record. In some embodiments, in addition to identifying the file type as a delimited file type, the algorithm also returns the delimiters and/or column headers found. The algorithm can identify a file as having a SCF file type if a record length of the file has 80 characters and the social security number (SSN) in columns 13 to 23 has dashes, which is typical for SCF files used for certain healthcare companies. In addition, as a default, for any file that cannot be identified as an ANSI file, a SCF file, a delimited file, or an Excel file using the approaches described above, the algorithm classifies the file as a fixed-width file.

At step 204 of process 200, the table creation module 116 of the file processing system 100 is adapted to apply file type specific processes to automatically convert each file received into a single table storing data from the file. For each file received with an identified file type, the table creation module 116 first creates a single empty data table with a system-assigned name or a user-specified name along with an error log table to track any errors that may occur during the conversion process. In general, each data table includes (i) one or more records with each record forming a row of the table, (ii) one or more fields with each field forming a column of the table, and (iii) a key field per record storing a unique identifier of the record. The number of records and fields in the data table is dependent on the amount of data from the file. The table creation module 116 is adapted to load/enter data from the file into the correct records and fields in the table.

For an Excel file, the table creation module 116 is adapted to import the Excel spreadsheet into the newly created data table with high correlation, i.e., by populating fields in the table with fields from the spreadsheet. More specifically, the table creation module 116 can open the data table that is already imported and create and populate the standard FileOrder and KeyField fields if these fields are passed as parameters.

For an ANSI file, the table creation module 116 first creates an empty table with the correct number of records (i.e., rows) and fields (i.e., columns) by scanning the file in its entirety to identify segments present and the maximum number of elements per segment. The table creation module 116 creates in the data table with one record (i.e., row) per set of member data and one field (i.e. column) per segment and element combination using the segment name and order as the column name. The table creation module 116 can also create email and phone fields separately so that file order does not impact the data load. Then, the table creation module 116 is adapted to enter the data from the ANSI file into the respective records and fields of the data table. For example, the table creation module 116 is adapted to load ANSI header records of the file into a record of the table and load data between segments of the file into a single record per person by using segment identifiers and order to load data to the table in the correct fields.

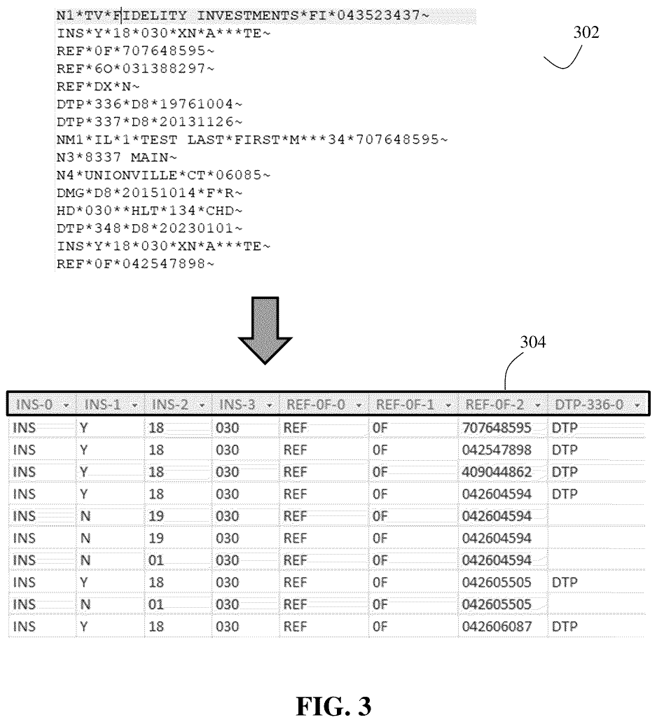

FIG. 3 shows conversion of an exemplary ANSI 834 file 302 into a data table 304 using the conversion process 200 of FIG. 2, according to some embodiments of the present invention. As shown, because an ANSI file 302 typically uses the “INS” segment to identify when a person's data starts, the table creation module 116 can load the data between “INS” segments into a single record per person in the corresponding data table 304. The table creation module 116 can use the segment identifiers and order to load data to the table 304 in the correct fields. In addition, the table creation module 116 can enter ANSI fixed Key values into the record keyfield for file compare purposes and load ANSI trailer records into the last table record. Optionally, the table creation module 116 can replace generic column headers with descriptive names found in a table of standard ANSI names.

For a delimited file, the table creation module 116 first creates an empty table with the correct number of records (i.e., rows) and fields (i.e., columns) by determining the maximum number of delimiters used per record and configuring the appropriate table format to accommodate. If pre-identified column headers have been provided, the table creation module 116 uses these names to create in the table one field per header. If the file has a record of column headers, the table creation module 116 uses these names to create one field per header. If no headers are present, the table creation module 116 determines the maximum number of delimiters per record in the file and creates fields in the table with generic names, such as “Column1, Column2 . . . ” etc. In some embodiments, the table creation module 116 adds one or more overflow columns into the table with names such as “Overflow”. These overflow columns are used for any data issues where the delimiter may have been used incorrectly in data values. Then, the table creation module 116 is adapted to enter the data from the delimited file into the respective records and fields of the data table. For example, the table creation module 116 can choose to skip loading of the first record in the file if it only contains header names.

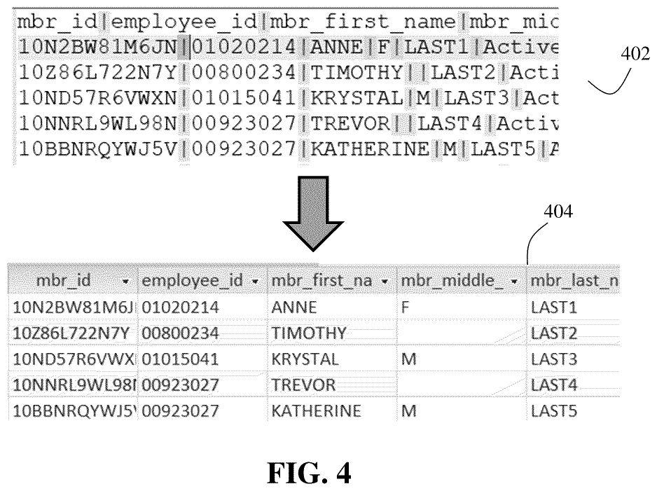

FIG. 4 shows conversion of an exemplary delimited file 402 into a data table 404 using the conversion process 200 of FIG. 2, according to some embodiments of the present invention. As shown, the table creation module 116 can load each record of the file 402 into a corresponding record of the table 404 using the delimiters (e.g., |) to move between elements. If key fields are pre-identified, the table creation module 116 can enter Key values into the record key fields for file compare purposes. Otherwise, the table creation module 116 can leave the key fields blank and the IdentifyKeys module will calculate. In some embodiments, the table creation module 116 also checks for any data in the overflow columns and give user a warning message if any exists.

For a SCF file, the table creation module 116 first creates an empty table with the correct number of records (i.e., rows) and fields (i.e., columns). To accomplish this, the table creation module 116 scans a predefined number of records (e.g., first 5000 records) in the file to identify all the record types in use. The table creation module 116 then creates in the table one record for each unique record type in the file. The table creation module 116 also creates in the file table a predefine number of fields (e.g., twenty fields) per record to hold data. Then, the table creation module 116 is adapted to enter the data from the SCF file into the respective records and fields of the data table by using a fixed-width pattern matching scheme on each record type.

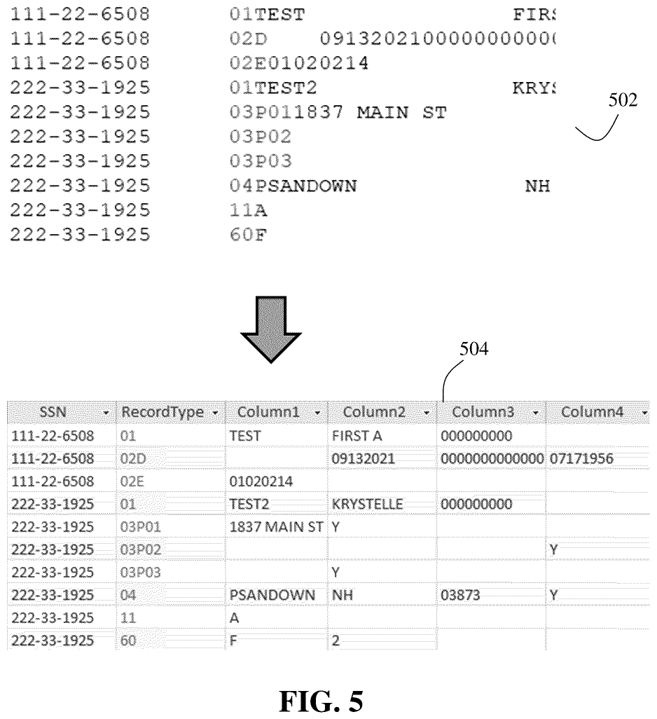

FIG. 5 shows conversion of an exemplary SCF file 502 into a data table 504 using the conversion process 200 of FIG. 2, according to some embodiments of the present invention. As shown, the table creation module 116 can process each different record type (01, 02D, 02E, etc) as a fixed-width record. It uses a sample size of the first number of records (e.g., 100 records) of each record type and runs fixed-width analysis on that sample to identify the column breaks. Details of the fixed-width analysis process provided below. Once the column breaks are identified, data is loaded to the tables for each record type.

For a fixed-width file, the table creation module 116 first creates an empty table with the correct number of records (i.e., rows) and fields (i.e., columns). More specifically, the table creation module 116 can use a pattern-matching algorithm to automatically determine column breaks in the file and set columns/fields for the corresponding table. Patterns can comprise one or more of multiple spaces, single space, date in one or more formats, currency in one or more formats, social security number in one or more formats, other numbers, and/or alpha/numeric transitions. For example, the list of patterns can include, but is not limited to:
Multiple spaces
Single spaces
Dates—yyyy-mm-dd
Dates—yyyymmdd
Dates—mm-dd-yyyy
Dates—mm/dd/yyyy
Dates—mmddyyyy
Currency—0.00
Currency—signed numeric {
Alphabetic/Numeric transition
Gender—M, F, U, X
Yes/No
SSN—xxx-xx-xxxx
SSN—xxxxxxxxx
Plan Codes after MED/DEN/VIS

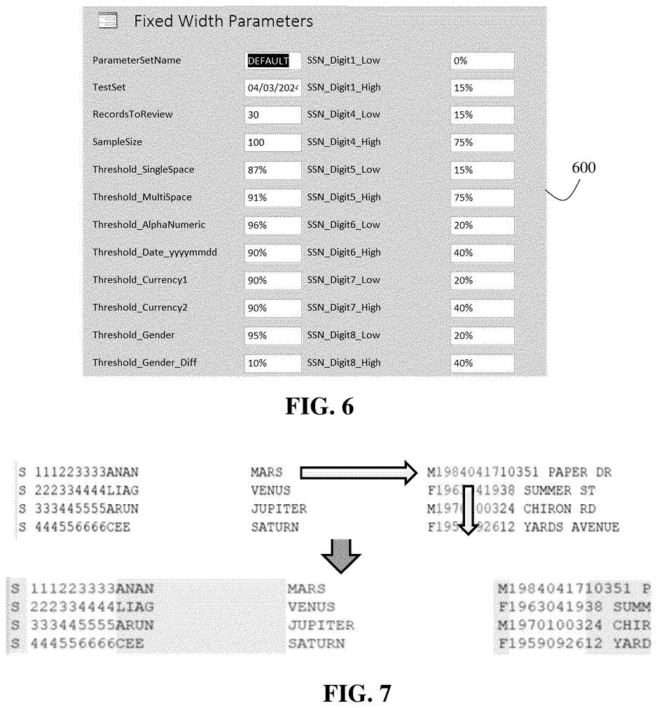

In some embodiments, the patterns are defined by a set of parameter settings input into the file processing system 100 by the input module 114. In addition, a user can also specify, via the input module 114, the number of records to review in the fixed-width file to identify potential patterns and the number of records (“sample size”) to review to verify these potential patterns for consistency purpose. In some embodiments, the number of records to review for detecting potential patterns in the first search is less than the number of records (sample size) to use to verify the consistency of these potential patterns in the second search. FIG. 6 shows an exemplary graphical user interface (GUI) 600 provided by the input module 114 of the file processing system 100 of FIG. 1 for allowing a user to specify parameter settings, sample size, and other variables for determining patterns in a fixed width file, according to some embodiments of the present invention. In some embodiments, a user can specify percentages for these settings instead of fixed threshold values to allow for inconsistent or incorrect data in a file. For example, if a user specifies 100 record sample size and 96% threshold for detecting alphabetic/numeric transitions, this means that 96 of the 100 records would need the alpha/numeric transition in the same column to be identified as a column break. Four of the records can have null values or other data that does not meet the criteria, but a break would still be identified. Usage of percentages to specify parameter thresholds is useful for files where data may be missing or incorrect.

After receiving the information via GUI 600, the table creation module 116 searches through a first subset of records in the fixed-width file to look for the specified patterns, subsequently identifying a set of potential patterns in the file. The first subset of records can be the first number of records in the file as specified by the number of records to review inputted by the user. Each potential pattern can be identified based on a single character or a sequence of multiple characters in a specific order as specified by the parameter settings. After the potential patterns are identified from the first subset of records in the file, the table creation module 116 can search through a second subset of records in the file to determine the number of times each potential pattern (identified from the first search) is repeated in the second subset of records. The second subset of records can be the subsequent number of records (after the first subset of records) in the file as specified by the sample size inputted by the user. In some embodiments, if the number of times a potential pattern repeats in the second subset of records exceeds a threshold, the table creation module 116 is adapted to enter the pattern into a column list, which serves as a map of all the identified columns for the table. Thus, the resulting data table comprises patterns from the column list as fields/columns and records as rows.

For a fixed-width file, once all the rows and columns are determined, the table creation module 116 is configured to read data from the fixed-width file into the table by mapping to the appropriate row/column in the table. FIG. 7 shows conversion of an exemplary fixed-width file 702 into a data table 704 using the conversion process of FIG. 2, according to some embodiments of the present invention. As shown, the table creation module 116 can load each record of the file 702 into a row of the table 704 and use the column list to map data to the appropriate columns of the table 704. If key fields are pre-identified, key values are entered into the record key field for file compare purposes.

In some embodiments, a fixed width file includes multiple formats per record type in the same file. This is common for files where there is a primary-type record and sub-records of the primary. Therefore, the table creation module 116 is suitably configured to map data of different formats into the table if those formats use an indicator data field at the start of each record. In an exemplary mapping process for a multi-format fixed width file, the table creation module 116 first reads in the first 10 characters of the first 200 records and store to a temporary table. If there are less than 50 records, the process exits as there is not enough data to accurately model multiple formats. If the first 10 characters include space characters or change from non-numeric to numeric, the table creation module 116 is adapted to isolate the first record characters up to that space or transition as potential multi-format indicator data field. The table creation module 116 then checks the unique value count on the trimmed list. If there are 5 or fewer unique values, these could indicate a multi-format indicator. If higher than 5 then the process exits as there are too many unique values. The table creation module 116 also checks for alternating patterns by comparing consecutive records in the trimmed list. If the values alternate less than 10 times across the sample data, the process exits as there is not enough alternating. The table creation module 116 further checks, if the file is longer than the original 200 records input, for consistency across the first 2000 records and verify that each record starts with one of the pre-identified tags. If the 2000 record check fails, the analysis is re-run on the 2000 records with only the first record character instead of the 10 character subset as one last check for alternating tags.

Referring back to FIG. 2, at step 206 of process 200, after the input files are converted to their respective table formats, a user can compare any two files using the comparison module 118 of the file processing system 100. In some embodiments, once a file is converted to table format, the comparison module 118 determines the unique record keys for the table and uses the record keys for comparing data between two files at a record and element level. For example, a unique record key can be generated based on (i) an employee social security number, department social security number or first name for an ANSI file, (ii) an employee social security number and record tag for a SCF file, or (iii) 1 to 3 fields that give rise to the most unique combination for other file types. The comparison can be accomplished by comparing respective data tables of two files, including comparing data of same record keys between the two files, to determine one or more differences between the files. Such comparison can result in finding records that are in File 1 but not in File 2 (using the key values in the key fields), finding records that are in File 2 but not in File 1 (using the key values in the key fields), finding field headers (e.g., entire columns) in File 1 but not in File 2, finding field headers (e.g., entire columns) in File 2 but not in File 1, and/or determining value differences in common records and fields as identified by the key fields and column headers. In some embodiments, the comparison module 118 is adapted to generate reports based on the comparison, such as outputting the comparison results in an Excel spreadsheet.

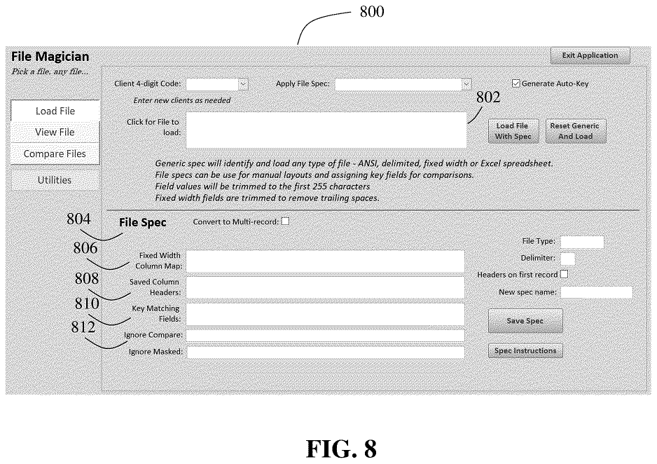

FIG. 8 shows another graphical user interface (GUI) 800 provided by the input module 114 of the file processing system 100 for receiving input files from a user for table conversion and comparison purposes using the process 200 of FIG. 2, according to some embodiments of the present invention. As shown, GUI 800 includes a field 802, through which a user can input one or more files with same or different file types. The identification of each file and record type can be saved as metadata for a file called a “File Spec” 804. This metadata can include any column break maps 806, header values 808, and data elements used for key fields 810. The user can also save a list of specific data elements to ignore when comparing files via field 812 to avoid false positives for data they do not expect to match.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A method for automatically comparing two text files comprising a first file and a second file, the method comprising:
receiving, by a computing device, the first and second files with respective file types, wherein the file type of the first file is a fixed-width file type;
converting, by the computing device, each of the two text files into respective ones of two tables, each table storing data extracted from the corresponding text file, wherein each table comprises (i) a plurality of records with each record forming a row and (ii) a plurality of fields with each field forming a column, wherein converting the first file that has the fixed-width file type comprises:
receiving, by the computing device, a set of parameter settings that define a set of patterns;
executing, by the computing device, a pattern-matching algorithm using the set of patterns on a first subset of the plurality of records to identify a set of potential patterns in the records;
executing, by the computing device, the pattern-matching algorithm using each of the set of potential patterns on a second subset of the plurality of records to determine a number of times each potential pattern is repeated in the second subset of records;
if the number of times a potential pattern is repeated exceeds a threshold, setting, by the computing device, the repeated potential pattern as a column of the first file; and
generating, by the computing device, the table comprising the records as the rows and the repeated potential patterns exceeding the threshold as the columns; and
comparing, by the computing device, the respective tables corresponding to the first and second files to determine one or more differences between the first and second files.

2. The method of claim 1, wherein the file type of the second file is one of American National Standards Institute (ANSI), delimited, fixed-width, SCF, or Excel file type.

3. The method of claim 2, wherein if the file type of the second file is ANSI, converting the second file into a table comprises:
scanning the second file in its entirety to identify segments present and a maximum number of elements per segment; and
creating one field per segment and element combination.

4. The method of claim 3, further comprising loading data from the second file into the table by:
loading ANSI header records into a first record of the table; and
loading data between segments into a single record per person by using segment identifiers and order to load data to the table in the correct fields.

5. The method of claim 2, wherein if the file type of the second file is delimited, converting the second file into a table comprises:
if the second file has column headers, using the column headers to create one field per header;
if the second file has no column headers, determining a maximum number of delimiters per record in the file and creating fields with generic column names based on the maximum number of delimiters.

6. The method of claim 5, further comprising loading data from the second file into the table by loading each file record into a record in the table using the delimiters to move between elements.

7. The method of claim 1, wherein the patterns comprise at least one of multiple spaces, single space, date in one or more formats, currency in one or more formats and social security number in one or more formats.

8. The method of claim 2, wherein if the file type of the second file is Excel, converting the second file into a table comprises creating and populating fields in the table with fields from the second file.

9. The method of claim 1, further comprising automatically identifying the file type of each of the two text files and automatically converting each file into its respective table based on its file type.

10. A computer-implemented system for automatically comparing two text files comprising a first file and a second file, the computer-implemented system comprising a computing device having a memory for storing instructions, wherein the instructions, when executed, configured the computer-implemented system to provide:
an input module configured to receive the first and second files with respective file types, wherein the file type of the first file is a fixed-width file type, the input module being configured to automatically determine the file type of the second file;
a table creation module configured to convert each of the two text files into respective ones of two tables, each table storing data extracted from the corresponding text file, wherein each table comprises (i) a plurality of records with each record forming a row and (ii) a plurality of fields with each field forming a column, wherein the table creation module is configured to convert the first file that has the fixed-width file type by:
receiving a set of parameter settings that define a set of patterns to be matched;
identifying a plurality of columns in the first file by scanning through each of the plurality of records in the first file to match the patterns, each identified pattern comprises a column;
generate the table comprising the records as the rows and the identified patterns as the columns; and
a comparison module configured to compare the respective tables corresponding to the first and second files to determine one or more differences between the first and second files.

11. The computer-implemented system of claim 10, wherein the file type of the second file is one of American National Standards Institute (ANSI), delimited, fixed-width, SCF, or Excel file type.

12. The computer-implemented system of claim 10, wherein if the file type of the second file is ANSI, the table creation module is configured to convert the second file into a table by:
scanning the second file in its entirety to identify segments present and a maximum number of elements per segment; and
creating one field per segment and element combination.

13. The computer-implemented system of claim 12, the table creation module is configured to load data from the second file into the table by:
loading ANSI header records into a first record of the table; and
loading data between segments into a single record per person by using segment identifiers and order to load data to the table in the correct fields.

14. The computer-implemented system of claim 10, wherein if the file type of the second file is delimited, the table creation module is configured to convert the second file into a table by:
if the second file has column headers, using the column headers to create one field per header;
if the second file has no column headers, determining a maximum number of delimiters per record in the file and create fields with generic column names based on the maximum number of delimiters.

15. The computer-implemented system of claim 14, the table creation module is configured to load data from the second file into the table by loading each file record into a record in the table using the delimiters to move between elements.

16. The computer-implemented system of claim 10, wherein the patterns comprise at least one of multiple spaces, single space, date in one or more formats, currency in one or more formats and social security number in one or more formats.

17. The computer-implemented system of claim 10, wherein if the file type of the second file is Excel, the table creation module is configured to convert the second file into a table by creating and populating fields in the table with fields from the second file.
